(19) United States
(12) Patent Application Publication
(10) Pub. No.: US 2018/0056613 A1
(43) Pub. Date: Mar. 1, 2018

(54) PROCESS FOR DISPENSING A CONTACT LENS FORMING FLUID MATERIAL

(71) Applicant: Novartis AG, Basel (CH)

(72) Inventors: Alice Weimin Liu, Alpharetta, GA (US); Steve Crowley, Peachtree Corners, GA (US)

(21) Appl. No.: 15/688,106

(22) Filed: Aug. 28, 2017

Related U.S. Application Data
(60) Provisional application No. 62/381,275, filed on Aug. 30, 2016.

(51) Int. Cl. B29D 11/00; B29C 39/24; B29C 39/42

(52) U.S. Cl. CPC B29D 11/00125; B29C 39/42; B29C 39/24

(57) ABSTRACT

A method for dispensing a material into a mold for forming contact lenses, comprises the steps of: (1) providing a contact lens mold, (2) providing a dispensing needle, wherein the dispensing needle is made from a material having a surface energy less than 32 dynes/cm, (3) arranging the contact lens mold underneath the dispensing needle, (4) dispersing a fluid composition into a mold for making a contact lens, wherein the fluid composition comprises a lens-forming material, and the lens-forming material containing a solvent and is crosslinkable and/or polymerizable by thermal curing or actinic radiation.

The invention relates to a method of dispensing a contact lens forming fluid material into a mold.

### BACKGROUND OF THE INVENTION

Today the mass manufacture of contact lenses, for example contact lenses which are disposed of after being worn is performed in a highly automated manufacturing process. Typically, in such process a predetermined amount of a starting material is dispensed into a female mold half, e.g. with the aid of a dispensing needle. Subsequently, the mold is closed with the aid of a corresponding male mold half, and thereafter the material contained in the mold is polymerized and/or cross-linked so as to form the contact lens. Depending on the starting material used it may contain a suitable amount of one or more solvents, which are often volatiles, so as to keep the starting material in a flowable state. If the amount of solvent is insufficient due to solvent evaporation, in particular during the manufacture of so-called silicon hydrogel lenses the lenses may show streaks or other defects or undesirable property changes on or in the formed lens which negatively affect optical properties or visual acuity of the lenses. To address the problem, US20110147957 A1 discloses a process for dispensing a flowable ophthalmic lens forming material comprising volatile solvent into a mold, the process comprising the step of dispensing being performed in a local gas atmosphere comprising the volatile solvent in vapor or gas form, substantially preventing volatile solvent from evaporating from the flowable material. In addition, US 20110147956 discloses a a process for dispensing a flowable ophthalmic lens forming material comprising volatile solvent into a mold, the process comprising the step of dispensing of the contact lens forming material into the mold cavity is accomplished while the male and female mold halves are associated with each other substantially gas-tight; and the mold cavity is connected with a dispensing channel, which is accessible from the outside of the contact lens mold and dispensing of the lens forming material is accomplished through this dispensing channel. Both processes are quite complicated.

Therefore, there is a need to provide an improved process for dispensing a material containing volatile solvent into a mold, in particular a material for forming ophthalmic lenses, e.g. contact lenses.

### SUMMARY OF THE INVENTION

The present invention relates to a method for dispensing a fluid composition comprising volatile solvent into a mold for forming contact lenses, comprises the steps of:

(1) providing a contact lens mold,
(2) providing a dispensing needle, wherein the dispensing needle is made from a material having a surface energy less than 32 dynes/cm,
(3) arranging the contact lens mold underneath the dispensing needle,
(4) dispersing the fluid composition into the contact lens mold, wherein the fluid composition comprises a lens-forming material, wherein the lens-forming material comprising volatile solvent and is crosslinkable and/or polymerizable by thermal curing or actinic radiation, wherein the dispensing needle is free of wicking and dripping after at least 20 more dispensing cycles comparing to the dispensing needle having a same diameter and made from a stainless steel when dispersing the fluid composition at a same set of conditions.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a dispensing system set up to be used with an example embodiment of the present invention.

FIG. 2 illustrates an example of wicking and dripping around a stainless steel needle.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

As used in this application, the term “ophthalmic lens” refers to an intraocular lens, a contact lens (hard or soft), or a corneal onlay. “Contact Lens” refers to a structure that can be placed on or within a wearer's eye. A contact lens can correct, improve, or alter a user's eyesight, but that need not be the case. A contact lens can be of any appropriate material known in the art or later developed, and can be a soft lens, a hard lens, or a hybrid lens. As used in this application, the term “silicone hydrogel contact lens” refers to a contact lens comprising a silicone hydrogel material.

As used in this application, the term “hydrogel” or “hydrogel material” refers to a crosslinked polymeric material which is not water-soluble and can contains at least 10% by weight of water within its polymer matrix when fully hydrated.

As used in this application, the term “non-silicone hydrogel” refers to a hydrogel that is theoretically free of silicon.

As used in this application, the term “silicone hydrogel” refers to a hydrogel containing silicone. A silicone hydrogel typically is obtained by copolymerization of a polymerizable composition comprising at least one silicone-containing vinylic monomer or at least one silicone-containing vinylic macromer or at least one silicone-containing prepolymer having ethylenically unsaturated groups.

As used in this application, the term “vinylic monomer” refers to a compound that has one sole ethylenically unsaturated group and can be polymerized actinically or thermally.

As used in this application, the term “olefinically unsaturated group” or “ethylenically unsaturated group” is employed herein in a broad sense and is intended to encompass any groups containing at least one carbon-carbon double bond (C═C). Exemplary ethylenically unsaturated groups include without limitation acryloyl, methacryloyl, allyl, vinyl, styrenyl, or other C═C containing groups.

As used in this application, the term “hydrophilic vinylic monomer” refers to a vinylic monomer which as a homopolymer typically yields a polymer that is water-soluble or can absorb at least 10 percent by weight water.

As used in this application, the term “hydrophobic vinylic monomer” refers to a vinylic monomer which as a homopolymer typically yields a polymer that is insoluble in water and can absorb less than 10 percent by weight water.

As used in this application, the term “macromer” or “prepolymer” refers to a medium and high molecular weight compound or polymer that contains two or more ethylenically unsaturated groups. Medium and high molecular weight typically means average molecular weights greater than 700 Daltons.

As used in this application, the term “crosslinker” refers to a compound having at least two ethylenically unsaturated groups. A “crosslinking agent” refers to a crosslinker having a molecular weight of about 700 Daltons or less.

As used in this application, the term “water contact angle” refers to an average water contact angle (i.e., contact angles measured by Sessile Drop method), which is obtained by averaging 10 measurements of contact angles.

As used in this application, the term “polymer” means a material formed by polymerizing/crosslinking one or more monomers or macromers or prepolymers.

As used in this application, the term “molecular weight” of a polymeric material (including monomeric or macromeric materials) refers to the weight-average molecular weight unless otherwise specifically noted or unless testing conditions indicate otherwise.

The term “fluid” as used herein indicates that a material is capable of flowing like a liquid.

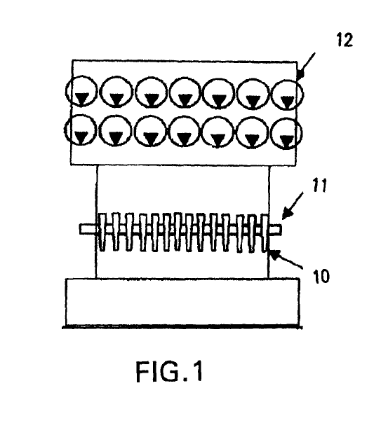

FIG. 1 shows a dispensing system set up to be used with an example embodiment of the present invention. The dispensing means which in the embodiment shown comprise a plurality of dispensing needles 10 fixedly arranged in a mounting bar 11. Also, a corresponding plurality of dispensing pumps 12 is shown in FIG. 1 with each dispensing pump 12 being associated to a particular dispensing needle 10. The number of dispensing needles 10 and dispensing pumps 12 can be chosen depending on the needs, however, in the embodiment shown fourteen dispensing needles 10 are fixedly arranged in mounting bar 11 and, correspondingly, a number of fourteen pumps 12 is provided.

For the dispensing step, first of all a number of female mold halves (not shown) corresponding to the number of dispensing t needles 10 is arranged beneath the dispensing t needles 10, with each individual female mold half being arranged beneath an individual dispensing needle with the aid of a suitable transport means which is known in the art. In this case, the female mold halves are transported until they reach the position beneath the respective d dispensing needles 10. Mounting bar 11 together with the dispensing needles 10 is then lowered until the dispensing needles 10 are arranged immediately above the surface of the female mold halves.

Once the mold has been completely closed, polymerizing and/or cross-linking of the “shaped” contact lens (the non-polymerized and non-cross-linked lens forming material in the completely close mold) is performed. After the lens forming material has been polymerized and/or cross-linked to form the lenses, the molds containing the polymerized and/or cross-linked lenses can be opened, and the lenses can be released from the molds, inspected, etc.

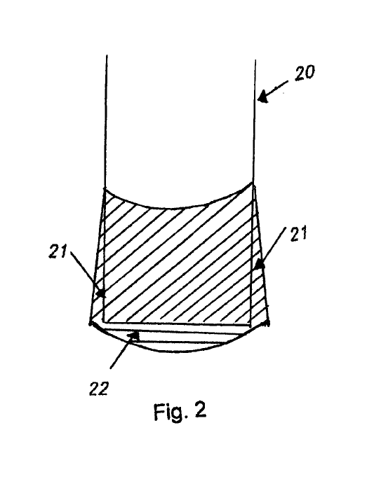

FIG. 2 illustrates an example of wicking and dripping of a lens forming flow material around a stainless steel needle.

When the lens forming material is dispensed through a needle (20), instead of forming a discreet neat drop (22) at the needle end, the lens forming material travels up along the outside of the needle. According to this patent application, the lens forming material up along the outside of the needle is referred as wicking (21). According to this patent application, the lens forming material moves up the side of the needle and forms droplets that fall back under their own weight. Combination of the forming material up the side of the needle and the droplets on the bottom of the needle is referred as dripping (21, 22).

In the process of making contact lenses, a predetermined amount of a starting lens forming fluid material is dispensed into a female mold half, e.g. with the aid of a dispensing needle. Subsequently, the mold is closed with the aid of a corresponding male mold half, and thereafter the material contained in the mold is polymerized and/or cross-linked so as to form the contact lens. Wicking and dripping is a constant problem during dispensing of lens forming fluid material. Wicking and dripping is a phenomenon, as explained through the capillary action, where the dispensed lens forming fluid material is drawn up the outside of the dispensing needle.

When dispensing viscous lens forming fluid materials whereby the needles get clogged and coupled with the problem of dripping results in a formulation mess on mechanical parts. Even for less viscous lens forming fluid materials, dripping and wicking are a great concern particular for the solvent based lens forming material whereby solvent evaporation leads to a concentration gradient in the lens forming material that in turn leads to optical distortion in the lenses. Both issues create adverse effects in contact lens product lines. The wicking (capillary action) wets the needle of the dispensing needle and causes evaporation of the formulation along with a sticky surface for airborne contamination. The dripping also causes evaporation and the increase surface area of a “cling” drip propagates this further.

Evaporation results in inhomogeneity of the lens forming material which is found in final products by measuring optical distortion. Another issue resulting from dripping pertains to the accuracy of the dispensing. With drips measuring on average of 5 μl can represent as much as 20% of the total dispense of small dispense amounts.

There are known lens forming fluid materials which include a solvent, for example silicone hydrogels (SiHy), which may contain alcohols, such as propanol or isopropanol or other, as a solvent. Solvents, for example propanol, however, are typically volatile. Thus, if a solvent containing lens forming material is dosed into the female mold half of the opened mold, at least a portion of the solvent evaporates before the mold is closed again. Due to the reduced amount of solvent the lens forming fluid material due to solvent evaporation changes its properties, which, after the lens forming fluid material has been polymerized or cross-linked may result in streaks or other defects or undesirable property changes on or in the formed lens. Such defects, such as streaks, if located in the vision area of the lens, may be intolerable so that the lens must be rejected after inspection. In addition, residues of lens forming material having a reduced solvent content may deposit at the needle of the dispensing unit and influence the accuracy of the next dispensing process in an adverse manner.

This is a phenomenon, as explained through the capillary action, where the material dispensed is drawn up the outside of the dispensing needle. This effect results in lens forming fluid material being exposed to the local environment which in turn results in evaporation, dripping, contamination among other problems. The issues with dripping and wicking are prevalent throughout all manufacturing platforms.

Depending on the starting material used it must contain a suitable amount of one or more solvents which are often volatiles so as to keep the starting material in a flowable state. If the amount of solvent is insufficient, in particular during the manufacture of so-called silicon hydrogel lenses the lenses may show streaks or other defects or undesirable property changes on or in the formed lens which negatively affect optical properties or visual acuity of the lenses. A further disadvantage which may occur especially during the manufacture of silicon hydrogel lenses is that small residues of starting material may remain on the dispensing needle and may negatively affect the accuracy of the amount of starting material dispensed into the mold, with the possible result that the lenses may be imperfect and have to be rejected.

The present invention is generally related to a method for dispensing a contact lens forming fluid material comprising volatile solvent into a mold for forming contact lenses for making (cast molding) silicone hydrogel contact lenses. The present invention is partly based on discovery that to use a dispensing needle which is made from a material having a surface energy less than 32 dynes/cm can greatly reduce, if not completely avoid, the occurrence of streaks or other defects in the manufactured lenses caused by the solvent evaporation problem during dispensing a contact lens forming fluid material into a mold is at least greatly reduces if not completely avoided. This is accomplished without dispersing the contact lens forming fluid material under atmosphere of organic solvent as disclosed in US20110147957 A1 or into the mold cavity while the male and female mold halves are associated with each other substantially gas-tight as disclosed in US 20110147956. The present invention is also partly based on discovery that to use a dispensing needle which is made from a material having a surface energy less than 32 dynes/cm is free of wicking and dripping after at least 20 more dispensing cycles comparing to the dispensing needle having a same diameter and made from a stainless steel when dispersing the fluid composition at a same set of conditions. According to the present application, a same set of conditions refers to the same needle size, the same dispense rate of the dispensing, and the same the same drawback volume. The test results indicate that the reduction of the wicking and dripping during dispensing lens forming fluid materials to contact lens mold also reduces the occurrence of streaks or other defects in the manufactured lenses caused by the solvent evaporation problem during dispensing a contact lens forming fluid material into a mold is at least greatly reduces, if not completely avoided. In addition, an accurate metering of the lens forming material into the mold shall be possible.

The present invention is generally related to a method for dispensing a fluid composition comprising volatile solvent into a mold for forming contact lenses, comprises the steps of:

(1) providing a contact lens mold,
(2) providing a dispensing needle, wherein the dispensing needle is made from a material having a surface energy less than 32 dynes/cm,
(3) arranging the contact lens mold underneath the dispensing needle,
(4) dispersing the fluid composition into the contact lens mold, wherein the fluid composition comprises a lens-forming material, wherein the lens-forming material comprising volatile solvent and is crosslinkable and/or polymerizable by thermal curing or actinic radiation, wherein the dispensing needle is free of wicking and dripping after at least 20 more dispensing cycles comparing to the dispensing needle having a same diameter and made from a stainless steel when dispersing the fluid composition at a same set of conditions.

Lens molds for making contact lenses are well known to a person skilled in the art and, for example, are employed in cast molding or spin casting. For example, a mold (for cast molding) generally comprises at least two mold sections (or portions) or mold halves, i.e. first and second mold halves. The first mold half defines a first molding (or optical) surface and the second mold half defines a second molding (or optical) surface. The first and second mold halves are configured to receive each other such that a lens forming cavity is formed between the first molding surface and the second molding surface. The molding surface of a mold half is the cavity-forming surface of the mold and in direct contact with lens-forming material.

In a conventional cast-molding process where a mold is used only once (i.e., disposable or single use), the first and second molding surface of a mold are pressed against each other to form a circumferential contact line which defines the edge of a result contact lens. Because the close contact of the molding surfaces can damage the optical quality of the molding surfaces, the mold cannot be reused. Examples of conventional non-reusable molds include without limitation those disclosed in PCT published patent application No. WO/87/04390, EP-A 0 367 513, U.S. Pat. No. 5,894,002, all of which are herein incorporated by reference in their entireties.

Lightstream Technology™ (Alcon) is an improved cast-molding process uses reusable molds and cures a lens-forming composition under a spatial limitation of actinic radiation. Examples of reusable molds suitable for spatial limitation of radiation include without limitation those disclosed in U.S. Pat. Nos. 6,627,124, 6,800,225, 7,384,590, and 7,387,759, which are incorporated by reference in their entireties.

According to the present application, both conventional disposable molds and reusable molds can be used and the silicone-hydrogel lens-forming composition is cured actinically or thermally to form a SiHy contact lens.

A silicone hydrogel (SiHy) contact lens formulation (lens forming fluid material) for cast-molding or spin-cast molding of contact lenses generally comprises at least one components selected from the group consisting of a silicone-containing vinylic monomer, a silicone-containing vinylic macromer, a silicone-containing prepolymer, a hydrophilic vinylic monomer, a hydrophobic vinylic monomer, a crosslinking agent (a compound having a molecular weight of about 700 Daltons or less and containing at least two ethylenically unsaturated groups), a free-radical initiator (photoinitiator or thermal initiator), a hydrophilic vinylic macromer/prepolymer, and combination thereof, as well known to a person skilled in the art. A SiHy contact lens formulation can also comprise other necessary components known to a person skilled in the art, such as, for example, a UV-absorbing agent, a visibility tinting agent (e.g., dyes, pigments, or mixtures thereof), antimicrobial agents (e.g., preferably silver nanoparticles), a bioactive agent, leachable lubricants, leachable tear-stabilizing agents, and mixtures thereof, as known to a person skilled in the art. Examples of silicone hydrogel contact lens materials have US Adopted Names of lotrafilcon A, lotrafilcon B, senofilcon A, galyfilcon A, balafilcon A, and comfilcon A.

In accordance with the invention, a SiHy lens formulation can be a solution or a melt at a temperature from about 20° C. to about 85° C. Preferably, a polymerizable composition is a solution of all desirable components in a suitable solvent, or a mixture of suitable solvents.

A SiHy lens formulation can be prepared by dissolving all of the desirable components in any suitable solvent, such as, water, a mixture of water and one or more organic solvents miscible with water, an organic solvent, or a mixture of one or more organic solvents, as known to a person skilled in the art.

Example of preferred organic solvents includes without limitation, tetrahydrofuran, tripropylene glycol methyl ether, dipropylene glycol methyl ether, ethylene glycol n-butyl ether, ketones (e.g., acetone, methyl ethyl ketone, etc.), diethylene glycol n-butyl ether, diethylene glycol methyl ether, ethylene glycol phenyl ether, propylene glycol methyl ether, propylene glycol methyl ether acetate, dipropylene glycol methyl ether acetate, propylene glycol n-propyl ether, dipropylene glycol n-propyl ether, tripropylene glycol n-butyl ether, propylene glycol n-butyl ether, dipropylene glycol n-butyl ether, tripropylene glycol n-butyl ether, propylene glycol phenyl ether dipropylene glycol dimethyl ether, polyethylene glycols, polypropylene glycols, ethyl acetate, butyl acetate, amyl acetate, methyl lactate, ethyl lactate, i-propyl lactate, methylene chloride, 2-butanol, 1-propanol, 2-propanol, menthol, cyclohexanol, cyclopentanol and exonorborneol, 2-pentanol, 3-pentanol, 2-hexanol, 3-hexanol, 3-methyl-2-butanol, 2-heptanol, 2-octanol, 2-nonanol, 2-decanol, 3-octanol, norborneol, tert-butanol, tert-amyl alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl-2-propanol, 2-methyl-2-heptanol, 2-methyl-2-octanol, 2-2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-propanol, t-amyl alcohol, isopropanol, 1-methyl-2-pyrrolidone, N,N-dimethylpropionamide, dimethyl formamide, dimethyl acetamide, dimethyl propionamide, N-methyl pyrrolidinone, and mixtures thereof.

Numerous SiHy lens formulations have been described in numerous patents and patent applications published by the filing date of this application. All of them can be used in a method of the invention. A SiHy lens formulation for making commercial SiHy lenses, such as, lotrafilcon A, lotrafilcon B, balafilcon A, galyfilcon A, senofilcon A, narafilcon A, narafilcon B, comfilcon A, enfilcon A, asmofilcon A, filcon II 3, can also be used in a method of the invention.

According to the invention, any materials may be considered for the dispense needles, however in respect of their surface energy must be below the value 32 Dynes/cm.

Table 1 lists the surface energy of various materials, whereby the values are taken from http://www.stevenlabel.com/Dyne.htm, the unit of surface energy: Dynes/cm.

TABLE 1
surface energy of various materials

| Material materials | Surface Energy, Dynes/cm |
|---|---|
| Stainless Steel | 700-1100 |
| Copper | 1103 |
| Aluminum | 840 |
| Polyester | 45 |
| Polycarbonate | 42 |
| PVC (Polyvinyl Chloride) | 42 |
| PVA | 37 |
| Polystyrene | 36 |
| Acetal | 36 |
| Polyethylene | 31 |
| Polypropylene | 29 |
| Polyvinyl Fluoride | 28 |
| Polydimethylsiloxane (PDMS) | 19.8 |
| Polytetrafluoroethylene (PTFE) | 18 |

### EXAMPLES

An IVEK servo controlled dispensing system (available from North Springfield, Vt. 5150 United States) with a minimum resolution of 0.5 μl is used for all tests. Needles with construction of Polypropylene, stainless steel, ceramic, and pure PTFE are evaluated. Dispensing needles made from Polytetrafluoroethylene are available from MicroGroup at 7 Industrial Park Road, Medway, Mass. 02053. Also tested were different formulations including Lotrafilcon A and B. The parameters for controlling the drip and wick for a lens forming material are: the type of material used for the dispensing needles, the use of drawback directly after the dispense (drawback rate and amount), the shape of the dispensing needle, the diameter of the dispensing needle and the dispense rate of the dispensing. All tests are carried out when lens forming materials reaches room temperature. Needles diameters are between 15 ga-22 ga and dispense rate are between 150-1000 μl/sec. The drawback amount is tested between 0-20 μl.

The baseline is an 18 ga surgical stainless steel needle with no drawback (0 μl), Lotrafilcon B lens forming material and 300 μl/sec rate as per use in the Double Side Mold manufacturing platform.

Test results indicate that dripping on all dispense needles could be improved upon from the baseline and in many test eliminated completely, but wicking was much more difficult to control due to factor such as surface of various needle materials. Results indicate the wicked lens forming material residing on the outside of the dispensing needle may be removed, or sucked, into the falling lens forming fluid material with each dispense cycle. This result is significant as any evaporation that occurs between dispense cycles resulting in inhomogeneity would for placed into the next dispensed formulation. The inhomogeneity results in a spot of optical distortion in that area. This is verified through slow motion photography.

Test results indicate that regardless of any test factors the stainless steel dispense needles would wick within 25 cycles. (a cycle is one dispense of 50 μl of formulation). Drawback helped for a few cycles but eventually wicking would build up to a saturation point and then remain consistent is size and replaced with each dispense cycle. The results of Ceramic are poor. The results for polypropylene needles are better than those for stainless steel dispense needles with the polypropylene needles staying wick free for about 50 cycles. The wicking amount for the polypropylene needles was much less than for stainless steel needles and ceramic needles. The dispense needle made from PTFE has even less wicking than dispense needle made from polypropylene under base line conditions. Wicking and dripping was completely eliminated by incorporating a small amount of drawback (1-20 μl).

The results of the study identifies the most important factor to reduce dripping and wicking is for the surface energy of the dispensing needle to be less than 32 Dynes/cm at 20° C., preferably less than 29 Dynes/cm, more preferably less than 20 Dynes/cm. The use of a surface energy less than 20 Dynes/cm material (for example, polytetrafluoroethylene for the needle coupled with a drawback and rate parameters can eliminate wicking and dripping for several test exceeding 150 cycles.

The invention has been described with the aid of a specific embodiment of the process or apparatus, respectively. However, the invention is not limited to the specific embodiment described but rather various changes and modifications are possible without departing from the general concept underlying the invention. Therefore, the scope of protection is defined by the appended claims.

1. A method for dispensing a fluid composition comprising volatile solvent into a mold for forming contact lenses, comprises the steps of:
(1) providing a contact lens mold,
(2) providing a dispensing needle, wherein the dispensing needle is made from a material having a surface energy less than 32 dynes/cm,
(3) arranging the contact lens mold underneath the dispensing needle,
(4) dispersing the fluid composition into the contact lens mold, wherein the fluid composition comprises a lens-forming material, wherein the lens-forming material comprising volatile solvent and is crosslinkable and/or polymerizable by thermal curing or actinic radiation, wherein the dispensing needle is free of wicking and dripping after at least 20 more dispensing cycles comparing to the dispensing needle having a same diameter and made from a stainless steel when dispersing the fluid composition at a same set of conditions.

2. Process according to claim 1, wherein the dispensing needle is made from a material having a surface energy less than 29 dynes/cm.

3. Process according to claim 2, wherein the dispensing needle is made from a material having a surface energy less than 20 dynes/cm.

4. Process according to claim 3, wherein the dispensing needle is made from Polytetrafluoroethylene.

5. Process according to claim 1, wherein the lens-forming fluid material comprise at least one components selected from the group consisting of a silicone-containing vinylic monomer, a silicone-containing vinylic macromer, a silicone-containing prepolymer, a hydrophilic vinylic monomer, a hydrophobic vinylic monomer, a crosslinking agent (a compound having a molecular weight of about 700 Daltons or less and containing at least two ethylenically unsaturated groups), a free-radical initiator (photoinitiator or thermal initiator), a hydrophilic vinylic macromer/prepolymer, and combination thereof.

6. Process according to claim 5, wherein the lens-forming material is lotrafilcon A, lotrafilcon B, senofilcon A, galyfilcon A, balafilcon A, or comfilcon A.

7. Process according to claim 6, wherein the solvent is propanol.
